(19) United States
(12) Patent Application Publication
(10) Pub. No.: US 2014/0375814 A1
(43) Pub. Date: Dec. 25, 2014

(54) Periphery Monitoring Device for Self-Propelled Industrial Machine

(71) Applicant: Hitachi Construction Machinery Co., Ltd., Tokyo (JP)

(72) Inventors: Hidefumi Ishimoto, Tsuchiura-shi (JP); Youichi Kowatari, Tsuchiura-shi (JP); Yoshihiro Inanobe, Tsuchiura-shi (JP); Eitaro Ito, Tokyo (JP); Kenta Tsukijishin, Tokyo (JP); Takaaki Ishii, Tokyo (JP)

(21) Appl. No.: 14/370,677

(22) PCT Filed: Jan. 10, 2013
(86) PCT No.: PCT/JP2013/050295

§ 371 Date: Jul. 3, 2014

(30) Foreign Application Priority Data
Jan. 12, 2012 (JP) 2012-003982
May 15, 2012 (JP) 2012-111198

(51) Int. Cl. B60R 1/00; H04N 7/18; G09G 5/14

(52) U.S. Cl. CPC B60R 1/00; G09G 5/14; H04N 7/181; B60R 2300/605; B60R 2300/607
USPC 348/148

(57) ABSTRACT

This invention discloses an around surveillance device for an automotive industrial machine to display camera images taken by plural cameras disposed on the automotive industrial machine having a display controller which comprises a view point convertor to convert the view point of the camera images to upper view point to create a bird's eye image, an image selector one or more images to be displayed on the monitor from a plural number of camera images and the bird's eye image, an image composite devise to compose an icon to indicate the position of the camera to be selected image from the image selector, and an image creator to create an composite image of the image composited said icon.

### FIELD OF THE INVENTION

The present invention relates to periphery monitoring device for self propelled industrial machine, that is, a surrounding surveillance device for an automotive industrial machine provided for surveying around a work machine for the purpose to ensure safety for performing, and to improve the efficiency of the works and the like.

### DESCRIPTION OF THE BACKGROUND ART

Various automotive industrial machines are developed and put into practical use. For example, a hydraulic excavator is operated for excavating earth and soil, and the excavated earth and soil are conveyed out by a dump truck. In a case where a person or any substance is placed around the automotive industrial machine, the component parts of the machine may cause contact or come into collision thereto, therefore an operator should pay attention to secure the circumference of the machine when operating the machine. Due to the operator is sited on an operator's cab during to make operation of the machine, the forward view field is to be assured with sitting on the operator's seat. Side mirrors are placed at the opposite sides of the cab, thereby view fields of these directions can also substantially be available. Further, the rearward field of view can be attained by means of a back mirror.

In a case of a dump truck for running loaded with earth and soil, for example, at least forward field of the travelling direction thereof should be ensured for the sake of security. The dump truck moves to backward direction in addition to forward travelling direction, further also driving to curved direction. Therefore, the field of view should essentially be secured toward the driving direction to some extent depending upon the driving speed, while not to be necessitated so wide in the view angle.

In this connection, the hydraulic excavator, as an automotive industrial machine, is able to travel, even though low traveling speed. The hydraulic excavator consists of a vehicular base structure having a normally crwaler-type travelling means and an upper swiveling structure being placed on the lower travelling mechanism. The upper swiveling structure can be rotated 360 degree to the vehicular base structure, and a working mechanism is provided on the upper swiveling structure. To secure the safety of the circumference of the industrial machine, perspective field of view is to be all around the machine, namely 360 degree, due to make rotation of the upper swiveling structure, and it is important the distance from the vehicle body to the surveillance object due to the working mechanism being performed expansion and contradiction.

There is somewhere critical to maintain the surrounding security by the operator's naked eye at the sitting posture in the operator's cab of the automotive industrial machine. In this connection, to make monitoring around the automotive industrial machine is known that a camera or cameras are installed to take images and a monitor is mounted in an operator's cab to display the camera images in the form of moving image. Further, due to the field of view of the camera has a certain limit in the range, auxiliary view field can be attained at an inspection brined area by the operator's eye with the provision of a plurality of cameras. The situation can be produced no brined for all around the industrial machine by providing several cameras, specifically to attain the view fields at directions of the rear ward, and left and right sides, or four directions including the fore ward view.

Cameras can be attained moving image forward the optical axis of the predetermined angle range and are able to see though up to a far distance. However, the distance from the automotive industrial machine to a surveillance object is hardly recognized merely from a camera directed to the forward direction. A virtual image can be created by processing to convert the view point of the camera image taken by the camera directed downwardly from a certain height position. In a case where the camera through image is displayed on the monitor, far distant through image can be shown, while the distance from the position of the camera to the surveillance object can be recognize from a bird's eye image by displaying on the monitor. Both camera through image and bird's eye image can be obtained the camera placed to be oblique forwardly. For this purpose, the camera is provided for inclined downwardly, but as to the field of view it is restricted for the distant image in proportion to the downward direction. Therefore, for the purpose to attain the necessary field of view, adjustment is necessary for the angle, position and direction of the camera.

Patent document 1 discloses a hydraulic excavator having surveillance cameras at the rear ward and right side which are brined sides for the operator and being mounted a monitor for displaying such a camera through image or the camera through image and a bird's eye image simultaneously arranged vertically. According to Patent Document 1, in a case where the camera is placed toward the rear ward direction, the camera through image is displayed, while cameras are positioned toward rearwardly and right side direction, 2 camera images which are taken from these two cameras are displayed or otherwise may be displayed the through image and the bird's eye image.

In a case where two cameras are provided, each scope of the view field of respective cameras are simultaneously indicated in the displayed, for this purpose a plane view of the hydraulic excavator on the monitor to show the extent of the view fields of respective cameras. In addition, an area of description is given on the monitor about which is the displayed camera image taken by the rearward camera or right side camera.

### PRIOR ART DOCUMENT

### Patent Document

International Publication Pamphlet WO2006/106685

### SUMMARY OF THE INVENTION

### Problem to be Solved by the Invention

The display size is restricted due to the monitor is placed in the operator's cab, thus the monitor restricted the display area should be utilized effectively in order to exhibit the efficiently of the surrounding surveillance image. The image should be sharp and easy to see, and the image area should be widened as far as possible. Plural cameras are installed on the automotive industrial machine for eliminating the brined area and in order to make display the images taken by these cameras in wide and easily visible manner during the operation status, images necessary to surveying the surrounding thereof should be displayed widely, further plural number of images are to be shown simultaneously. For the purpose as explained above, the image on the monitor should be displayed as wide as possible and the monitor is necessary to divide into plural parts. In addition, in a case where the operator cannot certainly recognize the camera image presently shown on the monitor, not only the object to make the surrounding surveillance cannot be attained, but also an inconvenience will be occurred confusion or the like.

The present invention is accomplished in consideration of the above mentioned aspect, accordingly, the object of the present invention resides in that image of the surrounding surveillance is displayed in easily visible and clearly manner to utilize the displaying area widely, further presently displayed image for surveillance use is securely identified the specific camera within plural cameras positioned thereon.

### Means for Solving the Problem

In accordance with the present invention, in order to achieve the above-stated object, there is provided a surrounding surveillance device for an automotive industrial machine to display on a monitor images processed by a display controller of camera images taken from a plural number of cameras disposed in said automotive industrial machine, characterized in that said display controller having a view point convertor to convert the view point of said camera images to upper view point to create a bird's eye image, an image selector to select one or more images to be displayed on said monitor from a plural number of camera images and said bird's eye image, an image composite device to compose an icon to indicate the position of said camera to be selected image from said image selector, and an image creator to create an composite image of said image composited with said icon.

Of the automotive industrial machine, a dump truck or the like is adapted to run at a high speed, but the direction to be surveyed is limited to the running direction, while in a case of a hydraulic excavator or the like is adapted to make swiveling movement and having a working mechanism to move toward the course of expansion and contraction, it is important to enter the view field into around the automotive industrial machine and to recognize the distance relative to an object to be avoid contact and collision, but not detrimental to need the field of view to far distant vision toward the running direction for the sake of security. The camera through image is useful to see substantially far distant, while the bird's eye view is necessary image to recognize the relative distance to an object to be avoided resided around the machine. Therefore, it is desired in light of safety to display both the camera image and the bird's eye image on the monitor, even though some difference in the importance. It is nevertheless to say, the surrounding surveillance device of the present invention is restricted to mount the dump truck and the hydraulic excavator, but other industrial machines such as a crane and the like.

The surrounding surveillance device provides plural number cameras around the machine, cameras are placed at least 3 places on the rear side, right and left sides of the machine, further 4 places including at the fore side even though available vision from the operator's cab, thereby eliminating brined area from all around the operator's cab. Therefore, at least 3 cameras, or 4 cameras, if the fore side camera being in addition thereto, are provided for the machine. Although five or more cameras may be provided by adding either or both side cameras, but it is not desirable due to be complicated the signal processing when so much cameras are provided. For this purpose, a wide angle lens is used as wide as possible, provided the optical axis of the lens is brought to turn obliquely downward direction.

The image displayed on the monitor is created from respective cameras, and can be displayed in the form of camera images or in the form of the bird's eye image. All camera images or all bird's eye images can totally be displayed on one single monitor. Further, a camera image and a bird's eye image, respectively at the different position, are simultaneously displayed on the monitor, or a camera image being displayed together with a bird's eye image positioned at the same place. The image selector can be selected combination and number of the camera image and the bird's eye image for displaying on the monitor.

In case to display all of the camera images on the monitor, the images are placed in line side by side, while respective bird's eye image is desired to dispose radial direction from the center of the monitor, due to the respective bird's eye images are taken in respective radial directions of the automotive industrial machine. Further, the center of the monitor is placed the image of the automotive industrial machine or a symbolized picture thereof, thus the foregoing disposition of the bird's eye view image being adapted in facilitating to recognize the status around the automotive industrial machine

One single image of the camera through view image or a bird's eye view image taken by one camera may be displayed on the entire area of the monitor. Therefore, the surrounding status comes to be displayed with enlarged image having a large in size by using the entire area of the monitor. The camera through view image and the bird's eye view image can be displayed on the monitor simultaneously. In this connection, to display on the monitor of the camera view image and the bird's eye image may be taken by the same camera or by different camera.

A display controller is connected to the monitor and an image selector is provided in the display controller in order to allow the selection to be displayed the view image on the monitor. As to the method for performing the selection, for example the selection is performed by scrolling respective view image and selecting it when the interested image is displayed. Otherwise, all camera images or all bird's eye images are displayed on the same screen, then setting can be performed to select one or plural number of the interested view images.

In a case where all bird's eye images are displayed around the central image of the automotive industrial machine (or the symbolized picture) on the monitor, the positional relationship between respective view image and respective camera is enable to recognize to some extent, while with respect to other view image, specifically to display one view image on the entire area of the monitor, one cannot or hardly recognize which is direction of the displayed view image. For this reason, an indication index is shown within the display area to identify which view image is displayed. The indication index includes at least the place (or disposed position) of the camera to be disposed on the automotive industrial machine, preferably together with the directional indication mark of the operator's cab at that moment. The icon has a symbolized pattern of the dictated automotive industrial machine or a symbol thereof. The camera position to be displayed may also be discriminated in the form of a color code with a color different to other portion of the component parts or make flashing etc.

In a case where plural number of the view image are displayed on the monitor, the icon is indicated for the respective view image. In a case where icons shown on respective view image are placed apart from each other, those icons are not rather preferable in visibility due to one should be largely moving the sight line when looking the icons. Therefore, each icon of respective view image brings to be positioned to the other icon as close as possible. By so positioning of the icons, respective icon can be seen with high visibility, and the operator can intuitively recognize the identity of the view image with the icon. Therefore, the indication is made a user-friendly manner.

In a case cameras are placed to survey the left side and right side of the automotive industrial machine, the camera image of the left side causes to rotate clockwise direction and the right side camera image being rotated counter-clockwise direction. By so constructed, the operator can be recognized the left and right sides view images with intuitively.

The area to be displayed is desired to be broad screen as wide as possible, although the screen area being limited to occupy on the display. For the foregoing reason, the icon can be limited to show in a predetermined period, after then the entire area of the monitor is used to show solely the view image by turn off the icon. Further, the icon can be restored to show upon request. In addition, the travelling direction of the automotive industrial machine can also be shown in a case of an upper swiveling structure is adapted to rotate to the traveling base structure, such as a hydraulic excavator.

### Effects of the Invention

The display area of the monitor can be utilized widely for surveillance around the automotive industrial machine, with ensuring to a highly-visible and clearly the surrounding images for surveillance of the automotive industrial machine, allowing without coursing confusion to identify the specific image from the plural images shown simultaneously, thus causing improvement of the surveying function qualitatively for the surrounding of the automotive industrial machine.

### BRIEF DESCRIPTION OF THE DRAWINGS

FIG. 1 is a front elevated view of a hydraulic excavator as an example of an automotive industrial machine.

FIG. 2 is a front elevated view of a dump truck as another type of an automotive industrial machine.

FIG. 3 is a schematic illustrative view shown disposition of cameras of a hydraulic excavator and a dump truck in addition with respective optical axis and field range of vision.

FIG. 4 is an exemplified view showing an operators cab of an automotive industrial machine.

FIG. 5 is an explanatory view of a principle to convert from a camera view to a birds eye view image.

FIG. 6 is an exemplary schematic view showing working area to be surveyed, together with a camera image and a birds eye image at the working area.

FIG. 7 is a block diagram to show the construction of a surrounding surveillance apparatus.

FIG. 8 shows an example of icon for indicated in a monitor.

FIG. 9 is an exemplified explanatory view of a total camera images and a birds eye image.

FIG. 10 is an exemplified explanatory view of a total birds eye view image and one individual birds eye view image.

FIG. 11 is an exemplified view showing the left side and right side camera images.

FIG. 12 is an explanatory view showing different aspect ratio of the monitor from FIG. 11.

FIG. 13 is an explanatory view showing on the monitor two view images to have different spacing.

FIG. 14 is an explanatory view showing in combination of a camera through image and a birds eye image on the monitor.

FIG. 15 is an explanatory view showing an icon of the running direction on the monitor in a case of difference in the direction of the hydraulic excavator and of the running direction.

### EMBODIMENT OF THE INVENTION

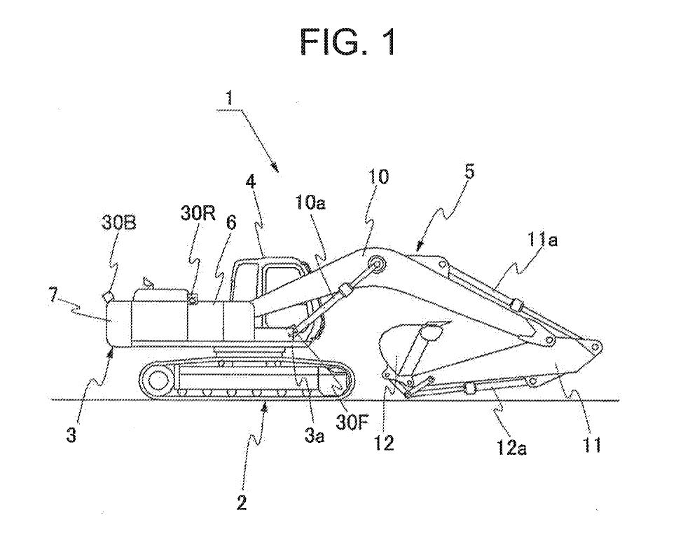

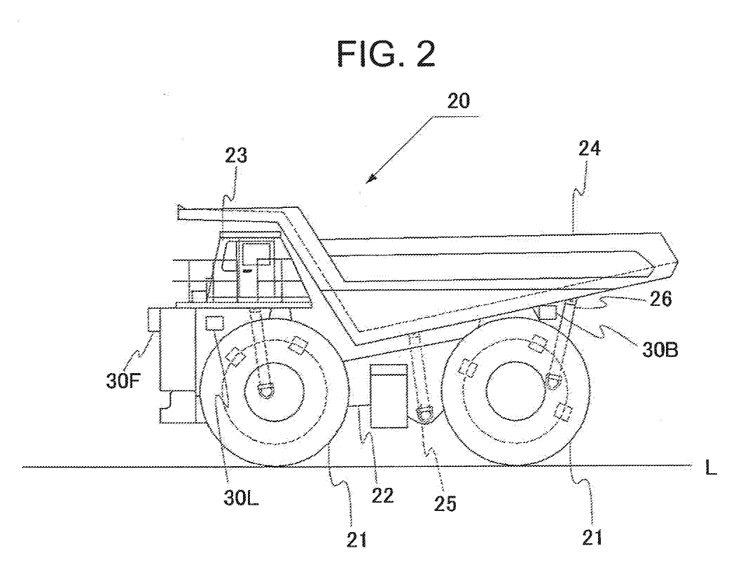

Embodiments of the present invention will be described below with reference to the attached drawings. First of all, a hydraulic excavator is shown in FIG. 1 as an automotive industrial machine, and a dump truck is shown in FIG. 2 as another automotive industrial machine.

The hydraulic excavator 1 shown in FIG. 1 constitutes a clawler-type vehicular structure 2 and an upper swiveling structure 3 adapted to perform swinging action on the vehicular structure 2. The upper swinging structure 3 has an operator's cab adapted to be operated by an operator and a working mechanism 5 for performing such as to excavate the earth and soil or the like. The working mechanism 5 is arranged at the right side of the operator's cab approximately side by side. Further, a machinery room 6 or the like is mounted at the rear side of the operator's cab 4 and the working mechanism 5, in addition a counterweight 7 is placed at the rearmost position.

The working mechanism 5 is composed of a boom 10, an arm 11 and a bucket 12 as a front attachment, which is a constituting of an excavating means for earth and sand. The boom 10 is pivotally connected at the proximal end to a flame 3a of the upper swiveling structure 3 used by a pivotal connecting pin and is adapted to make movement up and down. The tip end of the boom 10 is connected to the arm 11 so as to perform vertical movement up and down, and the bucket 12 is connected to the tip end of the arm 11 being able to perform rotational movement. The vertical movement of the boom 10 is actuated by a boom cylinder 10a. The arm 11 is actuated by an arm cylinder 11a, and the bucket 12 is actuated a bucket cylinder 12a. Therefore, the working mechanism 5 is able to change the posture to be folded between the boom 10 and the arm 11, and to be extended the boom 10 and arm 11 toward fore direction.

While, the dump truck 20 as shown in FIG. 2 has a chassis 22 provided with tires 21 as the travelling means, wherein a operator's cab is provided at a high position of the chassis 22, an operator performs the operation within the operator's cab. On the chassis 22, a vessel 24 is mounted to be loaded earth and soil and the like therein. The vessel 24 is adapted to tilt toward backwardly, thereby the loaded earth and soil being discharged from the chassis 22. A driving cylinder 25 and link mechanism 26 are connected between the chassis 22 and vessel 24, thus allowing for tilt the vessel 24.

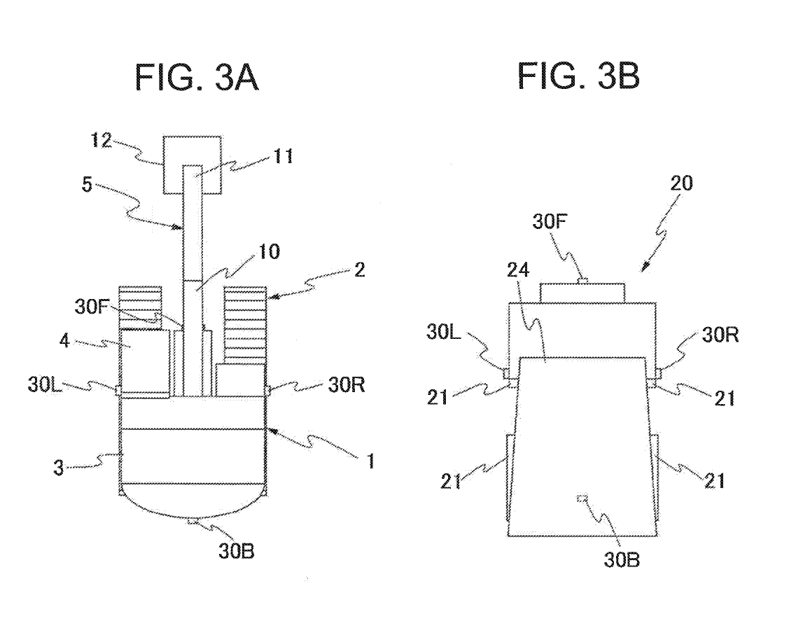

A plurality of cameras are mounted on the hydraulic excavator 1 and the dump truck 20 for the sake of surveying around the automotive industrial machine (vehicle) such as the hydraulic excavator 1, the dump truck 20 and the like. As for the hydraulic excavator 1 as shown in FIG. 3A, there are provided a rear ward surveillance camera (rearward camera) 30B, a right side surveillance camera (right side camera) 30R and a left side surveillance camera (left side camera) 30L, and in addition a fore ward surveillance camera (forward camera) 30F being also provided. In this connection the forward surveillance camera may not be necessarily provided. On the other hand, the dump truck 20 as shown in FIG. 3B has, similar to the hydraulic excavator 1, a rear ward surveillance camera (rearward camera) 30B, a right side surveillance camera (right side camera) 30R, a left side surveillance camera (left side camera) 30L, and a fore ward surveillance camera (forward camera) 30F being also provided. Hereinafter, the forward camera 30F, the rearward camera 30B, the rightward camera 30R and the leftward camera 30L are sometimes collectively called as the camera 30.

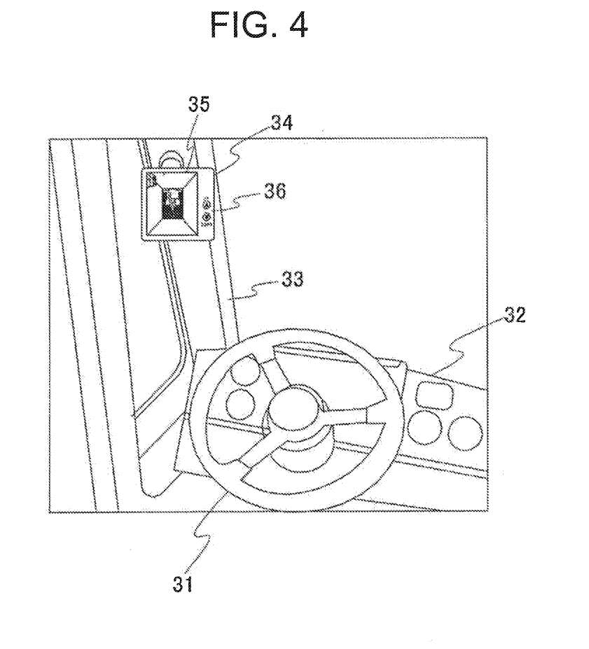

FIG. 4 shows an example of an operator's cab 23 of the dump truck 20 as the automotive industrial machine. In the operator's cab 23, a handle 31 is provided for traveling operation by the operator, and a console 32 is placed for instruments and the like. Also, a monitor 34 is provided at a pillar 33 at a position not to restrict the forward visual field of the operator. The monitor 34 has an image display section 35 for view image or the like taken by the camera 30 and input section 36 to control the display information.

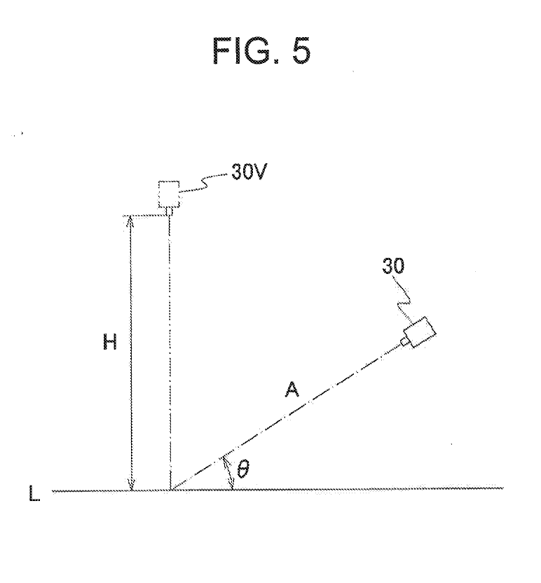

Then, respective cameras 30 are taken of the view image at a predetermined angle of the optical axis. An upper view point image, as a virtual view point image, can be created from the camera image by performing a predetermined signal process. Namely, as shown in FIG. 5, the optical axis A of the objective lens for the camera 30 is tilted downwardly to the ground surface L at a predetermined angle θ. Then, a view point conversion can be performed by making coordinate transformation to a bird's eye image downwardly looking from a virtual camera 30V mounted at a height H toward the ground surface L. The bird's eye view image is so created.

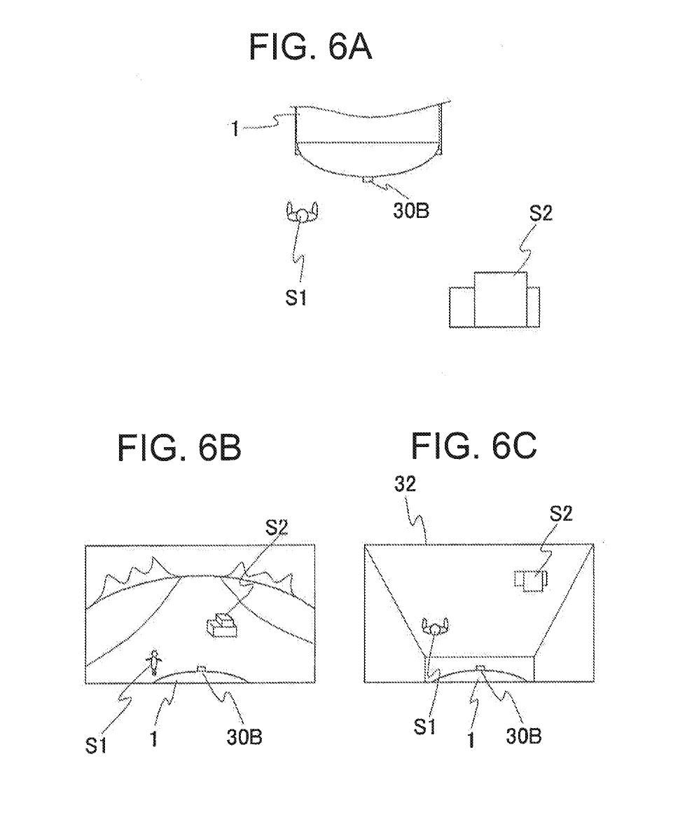

FIG. 6A shows the rear side of the hydraulic excavator 1 as the automotive industrial machine, a workman S1 and a construction S2 are resided at the rear position, these workman S1 and the construction S2 being objects to be surveyed the surroundings. The rear ward camera 30B takes a camera image (through image) as shown in FIG. 6B. A bird's eye image is created by performing the view point conversion process from the above-mentioned camera image. As apparent from these figures, the camera image of FIG. 6B is visible to far long distance in the axial direction. While, the bird's eye image in FIG. 6C is facilitated to recognize the distance between the hydraulic excavator and the object to be made surveillance

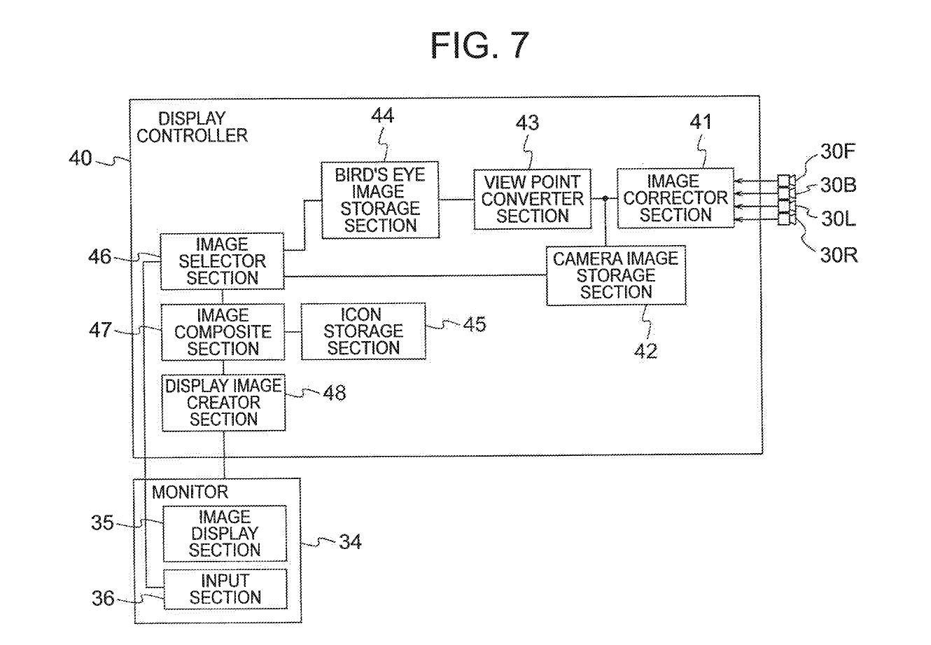

As described hereinbefore, the automotive industrial machine such as the hydraulic excavator 1, the dump truck 20 and the like is provided with cameras at the four positions, images derived from respective cameras are inputted as the camera images to a display controller 40. As shown in FIG. 7, these camera images which are inputted to the display controller 40 as image signals, then the image signals are processed to display the monitor 34. Respective camera images from the cameras 30 are transferred to an image corrector section 41. The image corrector section 41 performs correction of the image such as distortion correction, contrast correction, color correction and the like by means of camera optical parameters on the acquired camera image, thereby improving the quality of the attained image.

Respective camera images after done the correction processing are transferred to a camera image storage section 42 and a view point convertor section 43. Then, the view point convertor section 43 performs to convert to the upper view point image, thereby creating the bird's eye image. In this connection, camera images obtained by the fore ward camera 30F, the back ward camera 30B, the left side camera 30L and the right side camera 30R are converted independently to the bird's eye images. The created bird's eye images are transferred to a bird's eye image storage section 44. In addition, an icon storage section 45 is provided in the display controller 40. The icon is a symbol to indicate the position of the cameras 30 regardless whether the camera image or of the bird's eye image, the icon being stored in the icon storage section 45. Upon the surrounding surveillance image is displayed, the icon is shown superposedly.

The monitor 34 has the image display section 35 and the input section 36, the input section 36 has change-over means such as switches or the like. Input signals given from the input section 36 are transferred to an image selector section 46, thereby to read out a specific camera image or a specific bird's eye image from the camera image storage section 42 or the bird's eye image storage section 44 in order to display on the monitor 34. Therefore, when making selection to display the surveillance image (camera image or bird's eye image), a bird's eye image is read out from the bird's eye image storage section 44 or a camera image is read out from the camera image storage section 42. In this case, the surveillance image includes to be taken from one camera 30 but also plural cameras. The surveillance image selected from the image selector section 46 is further composited with the icon stored in the icon storage section 45, then through an image creation section 48, finally being displayed on image display section 34 of the monitor 34. In this case, the image composite section 47 determines the image position and the image size of the selected image to display on the image display section 35 of the monitor 34.

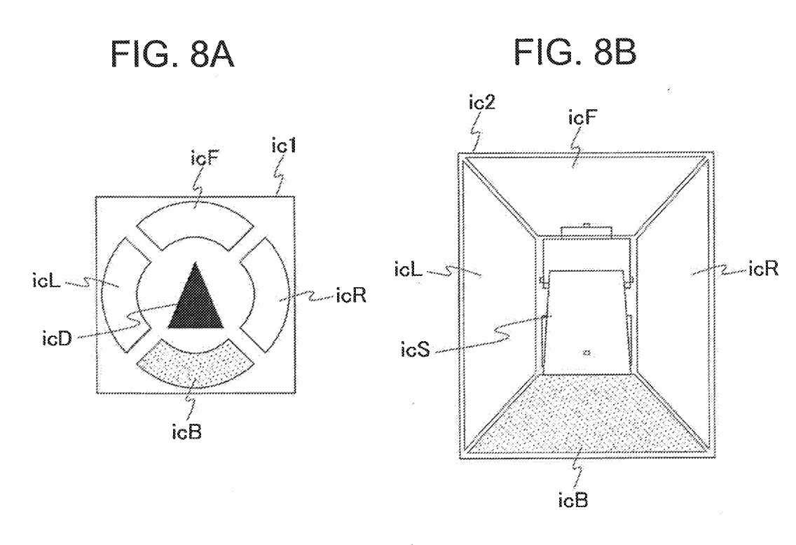

The icon for indication of the camera position is composed of the surveillance image on the monitor 34. The manner for indicating the icon is exemplified in FIG. 8. The indication appearance of the icon is not limited to as shown in FIG. 8, but other type of an indication appearance may be used provided that the direction of the automotive industrial machine and the position of the camera can be indicated clearly, the image being necessarily shown the direction of the automotive industrial machine and the position of the camera.

FIG. 8A shows the icon ic1 which is composited to the camera image. In shown the icon ic1 is the icD in the form of a triangle mark indicating the direction of the automotive industrial machine and plural number of arc segments are shown corresponding to the number of the cameras around the arrow icD. In accordance with the present embodiment, the icon ic1 consists of the icD which is divided into four arc segments portions of icB, icR, icL and icF provided around the center arrow mark icD as symbol codes. And the arc segment of the corresponding position of the displayed camera 30 is indicated with a color to differentiate from other arc segments. In the drawing, meshing shows in the arc segment icB for indicating different from other arc segments in color.

Therefore, the arrow mark icD of the icon ic1 denotes the indication of the fore direction and the four arc segments icB, icR, icL and icF denotes the indication of positions of cameras. The specific portion of the arc segment which indicates the position of the camera may be identified by, not limited to the color difference, other method such as lightening, flickering or the like. Further, hatching can be given as shown in the drawing. So, any display form can be adopted as long as to be identified the subject of the specific ark.

FIG. 8B shows an icon ic2 composited at the time of displaying the bird's eye image. In the drawing, the dump truck 20 is shown as an automotive industrial machine, wherein a symbol icO is displayed as a reproduction of the plane view. In addition, the surrounding space is divided radially into four areas of the forward, rearward, left side and right side to form icons icB, isT, icL and icF corresponding to the provided number of cameras. The position of one camera 30 is also adapted to make difference against the other areas by means of the differentiation using different color (hatched portion in the drawing), or lightening or flickering. In FIG. 6B, the icon icS is the forward direction indicator and the areas icB, ic R, ic L and icF are the camera position indicator of the positions of cameras 30.

In this connection, the icon ic2 of FIG. 8B may be composited to the displayed camera image, the icon ic1 of FIG. 8A may be composited at the time of displaying the bird's eye image. In brief, when any icon is used, optional indication method can be applied for the indication of the direction of the automotive industrial machine and the position of cameras.

The surrounding surveillance of the automotive industrial machine is so designed as to prevent contact with or collide against a surveillance object to be avoided, that is for example, a person such as a worker positioned surrounding the activity area under the operation of the automotive industrial machine, a stationary placed surrounding construction and the like such as a substance or a tree, or another vehicle. For this reason, an image of the automotive industrial machine is displayed on the monitor 34 and the displayed image is the camera image or the bird's eye image. The camera image is utilized to obtain information of the forward direction, and is necessarily to be visible of the object to be avoided in rather far away in consideration where the automotive industrial machine runs at high speed. However, the view angle may be limited due to the view range is sufficient to a predetermined angle range from the traveling direction as the center. On the contrary, the bird's eye image is adapted to have information as to surrounding situation of the automotive industrial machine, the important matter is the relative position between the automotive industrial machine and the object to be avoided, the relationship in these positions being important to know even though sacrificed the visible angle more or less.

In the automotive industrial machine, the hydraulic excavator 1 necessitates the bird's eye image, while the camera image is regarded to be important for the dump truck 20. However, the camera image not processed view point is also needed for the hydraulic excavator 1 for allowing to be recognized the image to be observed more clearly. Further, for the dump truck 20, to display of the bird's eye image is important to know the positional relationship with the object to be avoided.

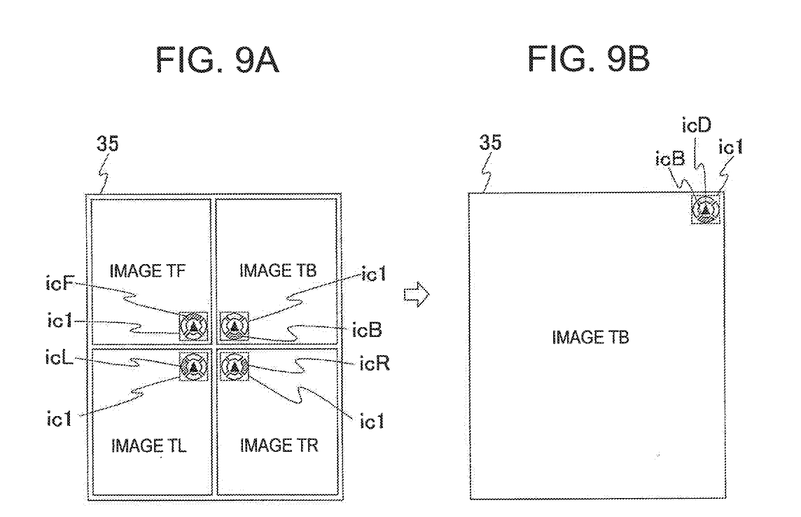

In the next place, the exemplified images to be displayed on the image display section 35 of the monitor 34 are explained hereinafter. An example shown in FIG. 9 is the total camera images. In FIG. 9A, four camera images TB, TR, TL and TF taken by the cameras 30 are totally shown together with the icon ic1, respectively.

The four images consisting of the total cameras are respectively shown on the image display section 35 of the monitor 34 divided into four areas in the form of cross shape as up, down, light and left. Displayed respective areas consist of the camera images together with icons to identify the position of respective cameras in composed thereof. In a case where the icon ic1 of FIG. 9A is adopted, each arc segment corresponding to the camera is colored with different colors from other segments, as shown the mesh pattern. Thereby, the positioning relationship between the camera images and the position of respective camera 30 are identified, thus preventing to cause misunderstanding for the operator when looking the monitor 34.

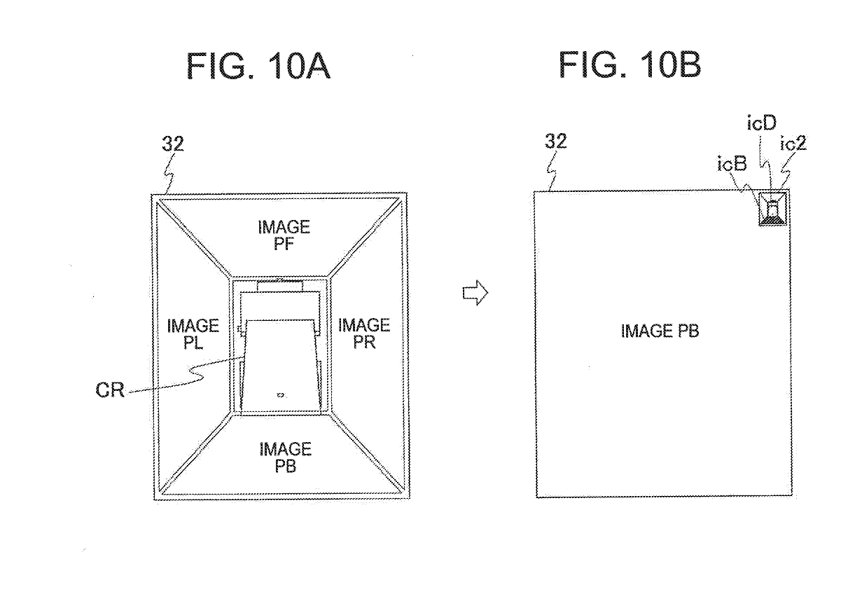

FIG. 10A shows the bird's eye image. The display of the bird's eye image consist of a character CR which is reproduction of the plan view of the dump truck 20 at the center, and four bird's eye images PB, PR, TR and TF which are converted the view point conversion from the four camera images TB, TR, TL and TF taken by the respective cameras 30 surrounding thereof. The display is total bird's eye view image. The character CR is the same as or similar to configuration of the symbol icS as shown in FIG. 8B. The character CR is greater in size than the icon icS, although the symbol icS is consisting of a part of the icon ic1 as such. The character CR indicates for the traveling direction as similar to the icon icS.

On or more of the images can be displayed on the monitor 34 extracted from the total camera view image as shown FIG. 9A or the total bird's eye view image as shown in FIG. 10A. The respective image is originally indicated the icon ic1 in the case of the total camera view image, it may be added the icon ic2 independently to the respective display area in the case of the total bird's eye view image. However, colored indication of respective area is not necessary by showing the character CR at the center of the monitor 34.

As shown in FIG. 9B or FIG. 10B, a single camera image or a single bird's eye image can be displayed from one of cameras, such as the rearward camera 30B. In this case, the single camera image or the single bird's eye image is displayed entirely of the image display section 35 of the monitor 34. Therefore, the image is displayed in magnified manner, so that the quality of the surrounding surveillance image is improved by clearly showing the detail of the magnified image.

The single camera image as shown in FIG. 9B is composed of the icon ic1 to identify the position of the camera 30. Among the arc segments icB, icR, icL and icF consisting of the icon ic1, the icon which has different color from the other icons is corresponding to the position of the camera 30 (the arc segment icB is selected in the case of the rearward camera 30B). Therefore, the displayed single camera image is clearly confirmed the direction of the image looking from the operator's cab 4, even though no description is given about the total image or the view range of the automotive industrial machine. Therefore, excess image should not be shown so that the single camera image can be displayed in the single camera image in maximum size.

The single bird's eye image as shown in FIG. 10B is also composited the icon ic2 to identify the position of the camera 30. Among the arc segments icB, icR, icL and icF consisting of the icon ic1, the icon which has different color from the other icons is corresponding position to presently displayed image from the camera 30 (the arc segment icB being selected in the case of the rearward camera 30B). Thereby, displayed bird's eye image can be identified the direction to look from the operator's cab4, the bird's eye image can be displayed in maximum size. Icon ic1 of FIG. 7A may be composited in place of the icon ic2 as shown in FIG. 10B. However, the icon ic2 is composited in the case where displays the bird's eye image, therefore, displayed image is adapted to be clearly denoted as the bird's eye image.

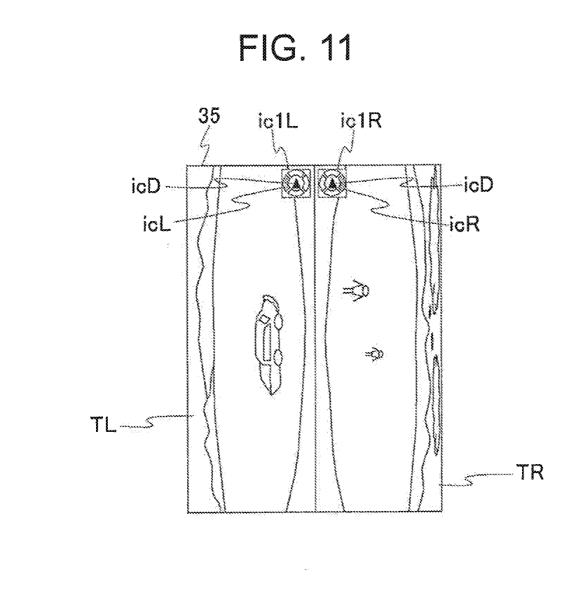

Not only a single camera image or single bird's eye image is displayed, but also a plural number of images can be displayed on the image display section 35 side by side. FIG. 11 is an example to display the two camera images TL and LR taken by the left side camera 30L and the right side camera 39R on the image display section 35. The camera image TL taken by the left side camera 30L (image TL) and the camera image LR taken by the right side camera 30R (image TR) can be displayed entirely or partially.

Although an example of two camera images are displayed in FIG. 11, two bird's eye images may be displayed. For example, the bird's eye image converted the view point of the camera image taken from the left side camera 30L and the bird's eye image converted the view point of the camera image taken from the right side camera 30R may be displayed side by side.

The image TL and the image TR are displayed in the enlarged scales. Therefore, the two enlarged camera image are displayed on the image display area of the image display section 35, even though smaller than the single image in scale. Therefore, the viewing field of right side and left side of the operator's cab 4 are attained from image display section 35 of the image TL and he image TR. Further, the icon ic1 is composited to indicate, respectively, the position of the camera 30 for the image TL and the image TR.

Due to the icon ic1 of the TL image (hereinafter referred as ic1L to differentiate from the icon ic1 of the TR image) is the left side field of vision, the left side arc segment icL is colored with other color than the other arc segments. While, the icon ic1 of the TR image (hereinafter referred as ic1R to differentiate from the icon ic1 of the TL image) is the right side field of vision, the left side arc segment icR is colored with other color than the other arc segments. By way of indicating as an index for icons ic1L and ic1R, it is clearly distinguished between the image TL is the left side view image and the image TR is the right side image, without given any specific explanation.

Then, as shown in FIG. 11, the icon ic1L and the icon ic1R are placed at the closed position each other. In other words, the icon ic1L is placed at the right side of the image TL and the icon ic1R is placed at the left side of the image TR. In this figure, the icon ic1L of the image TL is placed at the right side and the icon ic1R of the image TR is placed at the upper corner of the left side.

The icon ic1L and the icon ic1R come to be placed at the near position. Further, the icon ic1L is composed within the image TL and the icon ic1R is composed within the image TR. Thereby, the operator can be recognized the two icons practically not sifting the eye. In addition, the operator can be realized at a glance that the image TL is an image taken from the left side camera 50L and the image TR is an image taken from the right side camera 50R.

Specifically, the image TL is displayed at left half and the image TR is displayed at the right half. Therefore, the icon ic1L and the icon ic1R are positioned at the substantially center of the display screen. Supposing the operator resides the center of the monitor screen, the operator recognize intuitively the displayed image is either the left side image or the right side image taken from the camera 30 based upon the icon ic1L and the icon ic1R.

The embodiment explained above is referred to two camera images in FIG. 11, in a case where displaying the camera images in total, their icons ic1 are placed to the closed position, or being concentrated to the center of the display screen. By so constructing, the operator can be recognized four icons ic1 substantially without sifting the visual line. Therefore, one can easily judge with a fine visibility correspondence of the four camera images TB, TF, TR and TL with respective camera 30.

Then, the image TL and the image TR is rotated 90 degree as shown in FIG. 11. The image TL is rotated 90 degree to clockwise direction, and the image TR is rotated to counter-clockwise direction. Thereby, the operator can sensuously recognize with easy visible manner that the image TL (the camera image of the left side camera 30) is displayed at the left side of the image display section 35. Similarly, the operator can sensuously recognize with easy visible manner of the image TR displayed at the right side half of the image display section 35.

As explained hereinbefore, in a case of displaying plural number of images on the image displaying area 35, the visibility is improved by providing respective icon ic1 at the near place to each other. However, the object is attained even though the respective icon ic1 bringing apart each other, in a case where neglecting the visibility of the operator. In general, the operator can recognize the position of the camera 30 by composing the icon ic1 for the sake of identifying the camera 30.

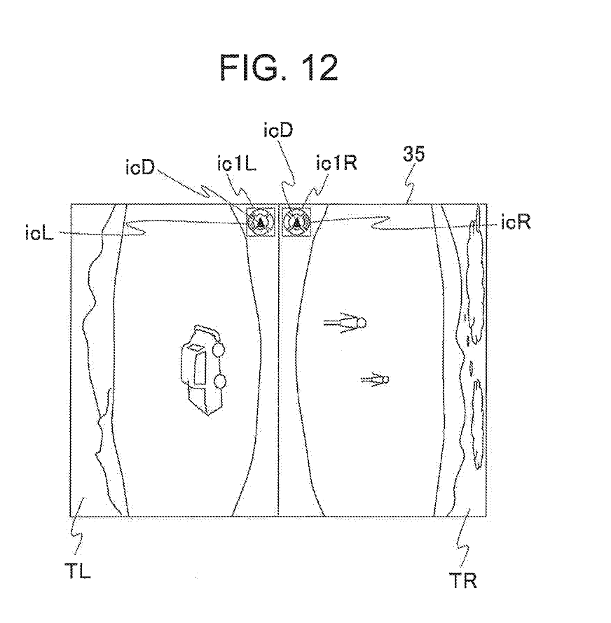

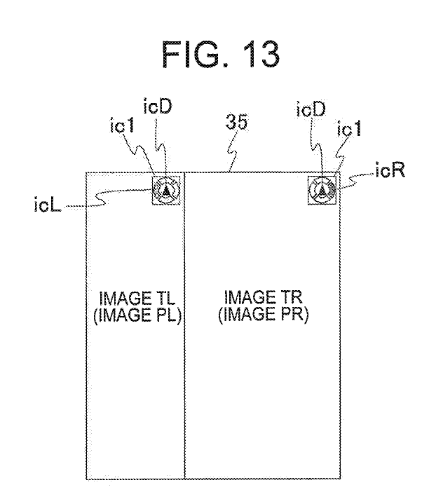

Though, in FIG. 11, explain is made in a case of vertical pixel number is larger in the aspect ratio, the same may be applicable to the transversal pixel number in the aspect ratio as shown in FIG. 12. Even though the image display section 35 is divided into equivalent size for displaying the image TL and the image TR in FIG. 11 and FIG. 12, the image TL and the image TR may be different in their sizes. The image region of the image LT is narrow and the image region of the image TR is wide in FIG. 13. In this connection, the image PL is the bird's eye image of the left side camera 30L, while the image PR being the bird's eye image of the right side camera 30R. Each arc segment may be varied in proportion to image display size.

In a case where the plural images are displayed side by side, three images may be displayed. At the time to display three bird's eye images, the position of the border line to divide each image is adapted to make variation in position. The icon ic1 to identify the position of the camera is preferably set to make variation in proportion to the width of the displayed image.

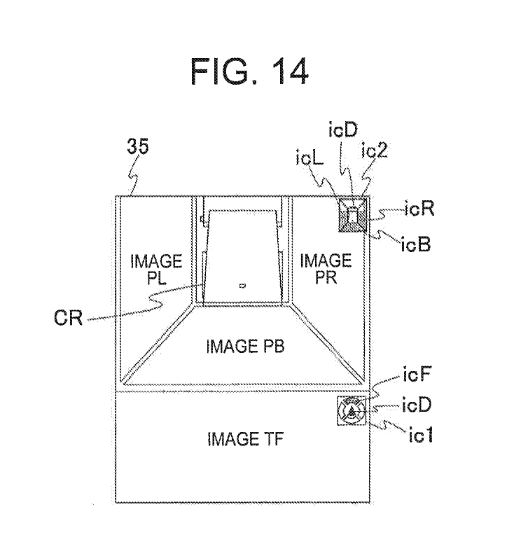

In a case where displays a plurality of images side by side, a camera image and a bird's eye image can combined. For example, as shown in FIG. 14, a combined image may be displayed simultaneously on the monitor 34 consisting of 3 bird's eye images taken by the backward camera 30B, left side camera 30L and right side camera 30R with a camera image by the camera 30F. In respect of the bird eye's images, one icon ic2 is indicated on the bird's eye images with colored with the same color in the arc segments icB, icR and icL. Yet, since the bird's eye images of the left side camera 30L and the right side camera 30R are partially shown, the colored region is not the entire areas icL and icR but restricted to the corresponding ratio of the displayed areas for the bird's eye images. On the contrary, the arc segment icF is limited at the fore direction to make colored.

In a case of the dump truck 20, displacement does not cause in operation between the operator's cab and the chassis 22 due to the operator's cab 23 is connected to the chassis 22 not to make swivel action, while as to the hydraulic excavator 1, the upper swiveling structure 3 mounted the operator's cab 4 is adapted to rotate against the vehicular base structure 2, thereby the vehicle can move not only forward direction but also reverse direction, when the fore running lever is operated under the situation that the upper swivel structure 3 is turned at 180 degree with respect to the vehicular base structure 2, therefore the vehicle being forcedly run not intended direction.

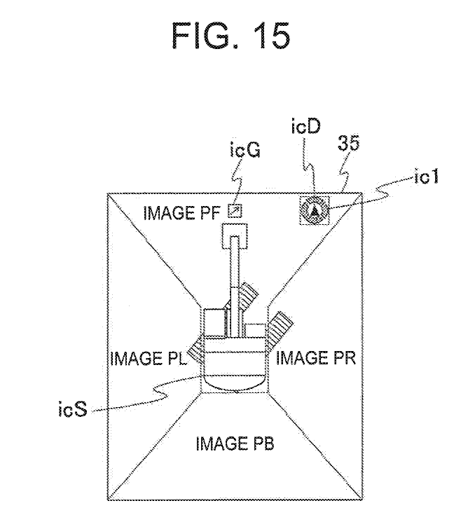

FIG. 15 shows an image consisting of the character CF at the center and surrounding four bird's eye images PF, PL, PR and PL, wherein the icon ic1 is composited on the image display section 35, the traveling direction of the operator's cab is indicated by means of the arrow mark icD. And the traveling direction of the hydraulic excavator 1 at the time of forward movement is indicated by an indication icon icG. Thereby, the operator can be recognized the traveling direction when operating to travel the hydraulic excavator 1 for the forward direction.

As explained above, in addition to the surrounding surveillance image, the icon is displayed on the image displaying area 35 of the monitor 34, thus restricting the surrounding surveillance image area by the icon indicating area. In this connection, the icon should not be indicated always but may normally be hidden from the display as far as recognized the information by the operator, thus eliminating the restriction for the surrounding surveillance image area. For this reason, the icon can be hidden from the display by the operation the operator, or the icon may be indicated during the predetermined time period, after then hidden from the display.

By so constructing, upon the operation of the automotive industrial machine such as the hydraulic excavator 1, the dump truck 20 and the like, the safety is confirmed around the automotive industrial machine. Therefore, the situation around the automotive industrial machine can be recognized quickly and accurately with respect to the closely presence of the surveillance object to be avoided, such as a worker or other person, a construction, a stationed object, tree or other vehicle. As a result, an accident, such as contact or conflict thereto can be prevented and the work efficiency is improved.

At the time of starting the automotive industrial machine from the from stopped state, the surrounding surveillance is performed to confirm the presence of surveillance object all around the automotive industrial machine. If necessary, some risk avoiding measure can be performed before starting the automotive industrial machine, such as giving notification to the worker or making detour the automotive industrial machine before starting.

The visibility of the forward direction to run should be secured for the dump truck as the automotive industrial machine at the time of the start. When the dump truck 20 travels forward direction, the image of the forward camera 30F is displayed on the monitor 34. And, since the camera image can be displayed on the entire screen of the monitor 34, the displayed image is adapted to show magnified in scale so as to attain detailed and conspicuous image information. In addition, by indicating with the icon ic1 for identifying the presently displayed image on the monitor 34, misrecognition is not occurred, thereby ensuring safety in operation.

In a case where the dump truck 20 runs backwardly and turns by the stealing operation, the image for the running direction is displayed. It is desired to appear the image for the running direction by way of the operation of the input section 36 or linking with the operation of the handle 31 or the operation lever. Further, in a case where the displayed image is intended to change over, objective image is easily selected from showing all camera images and all bird's eye images. Further, to select plural number of different images adapted to the surrounding surveillance, those images are shown in the manner of scrolling and allow to be selected by the operator.

In a case of the dump truck 20, the camera image is mainly displayed, and for performing fine stealing operation, the surrounding safety is secured by once displaying the entire bird's eye images. The bird's eye image is processed view point conversion so that the image per se is caused somewhat deteriorated. Such deterioration can be improved to display the concerned camera image solely or divided the image display area for showing the bird's eye image and the camera image.

On the contrary, in a case of the hydraulic excavator 1 as an automotive industrial machine, the displaying area of the surrounding is not necessary to have so wide due to slow in running speed, but essentially necessary to display is direction from upper view point image, that is entire bird's eye image. Therefore, the entire bird′ eye image is to be advantageously shown on the monitor 34. Further, a dangerous zone marking can be added to the monitor 34 with a predetermined radius from the center of the hydraulic excavator 1, thereby being assured to notice of the operator. Based upon the entire bird's eye image, suitable action to avoid the danger can be performed at the time of recognize the object to be avoided. Since the monitor 34 has a limited displaying area, the total bird's eye image may possibly be inferior in obtaining the detail information or causing unclear in the image. In such circumstances, one or more of bird's eye image can be enlarged or a camera image can be displayed in place of or together with the bird's eye image. Of course, the displayed image on the monitor 34 indicates the camera to be taken source of every images, the operator does not misunderstand or confuse the displayed image.

As explained above, on the operation of the automotive industrial machine such as hydraulic excavator 1 or dump truck 20, contact or conflict can be avoided of the automotive industrial machine or their part with an object, person or the like beforehand, thus being markedly improved in the safety of the work

### DESCRIPTION OF REFERENCE NUMERALS

1: hydraulic excavator
20: dump truck
30: camera
34: monitor
35: image display area
36: input area
40: display controller
41: image corrector section
42: camera image storage section
43: view point convertor section
44: image storage section
45: icon storage section
46: image selector section
47: image composite section
48: image creator section
50: camera
CR: character
ic1, ic2 icon

1. A surrounding surveillance device for an automotive industrial machine to display on a monitor images processed by a display controller of camera images taken from a plural number of cameras disposed in said automotive industrial machine,
said display controller having a view point convertor to convert the view point of said camera images to upper view point to create a bird's eye image,
an image selector to select one or more images to be displayed on said monitor from a plural number of camera images and said bird's eye image,
an image composite device to compose an icon to indicate the position of said camera to be selected image from said image selector,
and an image creator to create an composite image of said image composited with said icon.

2. A surrounding surveillance device for an automotive industrial machine according to claim 1, wherein said image selector is adapted to select a plural number of images composed of said camera image and said bird's eye image at the different positions, said camera image and said bird's eye image at the same position, all camera images, all bird's eye image, or optional one or plural number of said camera image and optional one or plural number of said bird's eye image.

3. A surrounding surveillance device for an automotive industrial machine according to claim 1, wherein said icon having a forward direction indicator for indicating the fore direction of said automotive industrial machine and a camera position indicator taken the displayed image.

4. A surrounding surveillance device for an automotive industrial machine according to claim 3, wherein at the time that said image composite section is displayed plural number of said images, said icons of respective image are closely disposed with each other.

5. A surrounding surveillance device for an automotive industrial machine according to claim 4, wherein said image composite devise rotates a left side camera image of said automotive industrial machine at the 90 degree toward clockwise direction, while rotates a right side camera image at 90 degree toward counter-clockwise direction.

6. A surrounding surveillance device for an automotive industrial machine according to claim 3, respective through images are displayed side by side when displaying all through images, while a plan view of said automotive industrial machine is positioned at the center of said monitor and respective bird's eye images are dispose around said plan view when displaying all bird's eye images.

7. A surrounding surveillance device for an automotive industrial machine according to claim 3, wherein said icon is indicated on said monitor during a predetermined time period and said icon is hidden after elapse of set time period.
